(19) United States
(12) Patent Application Publication
(10) Pub. No.: US 2013/0009120 A1
(43) Pub. Date: Jan. 10, 2013

(54) RADIOACTIVE MATERIAL HAVING ALTERED ISOTOPIC COMPOSITION

(76) Inventors: John J. MUNRO, III, North Andover, MA (US); Kevin J. SCHEHR, New Orleans, LA (US)

(21) Appl. No.: 13/531,833

(22) Filed: Jun. 25, 2012

Related U.S. Application Data
(60) Provisional application No. 61/500,227, filed on Jun. 23, 2011.

(51) Int. Cl. C09K 3/00

(52) U.S. Cl. 252/625

(57) ABSTRACT

Manufacturing a gamma radiation source includes providing an unacceptable material that is a combination of acceptable and unacceptable isotopes, transforming the unacceptable material into an acceptable material by removing unacceptable isotopes from the unacceptable material, leaving only acceptable isotopes, mixing selenium-74 and the acceptable material and heating the mixture to cause the constituents to inter-react and subsequently subjecting the reaction product to irradiation to convert at least a proportion of the selenium-74 to selenium-75. Manufacturing a gamma radiation source may also include adding at least one other acceptable material to the mixture. The at least one other acceptable material may be added to the mixture prior to heating the mixture. The unacceptable material may be selected from the group consisting of: Zinc, Titanium, Nickel, Zirconium, Ruthenium, Iron, Silver, Indium, Thallium, Samarium, Ytterbium, Germanium, and Iridium.

### CROSS-REFERENCE TO RELATED APPLICATIONS

This application claims priority to U.S. Provisional patent application 61/500,227 filed on Jun. 23, 2011 and titled: “RADIOACTIVE MATERIAL HAVING ALTERED ISOTOPIC COMPOSITION”, which is incorporated by reference herein.

### TECHNICAL FIELD

This application is directed to the field of producing radioactive materials.

### BACKGROUND OF THE INVENTION

The idea of encapsulating radioactive materials with materials that do not transmute into radioactive isotopes that emit undesirable radiations has been long known. Since the beginning of artificially-produced radioactive material in nuclear reactors, irradiation samples have been encapsulated in aluminum irradiation capsules because the aluminum produces only very short-lived radioactive species. Oak Ridge National Laboratory describes: “a set of 2-inch long aluminum capsules containing materials to be irradiated” in their high flux isotope reactor (HFIR) facility. (See http://neutrons.orn1.gov).

Nakajima, in U.S. Pat. No. 5,342,160, which is incorporated herein by reference, discloses that: “In a nuclear reactor, irradiation of radiation onto a sample is usually conducted, with the sample sealingly or shieldingly enclosed within capsules or metal or synthetic resin material.”

Since the advantage of placing the precursor material into a capsule that would not result in long-lived, unwanted radioactive materials was well known for the production process, it became known that this same approach and these same materials could be used for the ultimate encapsulation of the radioactive material. By pre-encapsulating a precursor into material which would not activate into a radioactive species, or would activate into a radioactive species with a short half-life relative to the desired radioactive species, then the result would be a radioactive source encapsulated within a capsule with no additional unwanted radiations.

Weeks and Schulz (in “Selenium-75: A potential source for use in high-activity brachytherapy irradiators,” Med. Phys. 13(5), pp. 728-731 (1986), which is incorporated herein by reference) report: “A vanadium capsule containing 5.9 mg of selenium powder was obtained from ORNL. The powder was specified to contain 77.7% by weight of ⁷⁴Se. Vanadium was chosen because neutron capture results in either stable or very short lived nuclei.”

Munro, in U.S. Pat. No. 6,400,796, which is incorporated herein by reference, discloses:
. . . In addition, as the capsule may be irradiated to activate the insert therein, the capsule should include materials that contain minimally acceptable amounts of isotopes that can be transmuted into radioactive isotopes that emit undesirable radiations. Moreover, if transmutation does occur, the radioactive isotopes should have such short half-lives or very low dose rates that their activities have little effect on healthy tissue.

In many cases, the precursor element has less than ideal physical properties (e.g., mechanical, thermal, chemical, etc.) which could be improved if the precursor element is combined with another chemical species. For example, combining Ytterbium with Oxygen to form Ytterbium Oxide (Yb₂O₃) results in higher density (r=9.17 mg/mm³) than Ytterbium metal (r=6.90 mg/mm³), resulting in a higher effective Ytterbium concentration. Also, combining Tantalum with Carbon to form Tantalum Carbide (TaC) results in increased melting temperature (3,880° C. v. 3,017° C.) and much greater hardness than Tantalum metal.

In the specific case of ⁷⁵Selenium, Shilton, (U.S. Pat. No. 6,875,377), which is incorporated herein by reference, describes the problem as follows:
In the past, ⁷⁵Selenium sources have been made by encapsulating elemental ⁷⁴Selenium target material inside a welded metal target capsule. This is irradiated in a high flux reactor to convert some of the ⁷⁴Selenium to ⁷⁵Selenium. Typically, target capsules are made of low-activating metals, such as aluminum, titanium, vanadium and their alloys. Other expensive metals and alloys are also possible. The use of these metals ensures that impurity gamma rays arising from the activation of the target capsule are minimized. The ⁷⁵Selenium is typically located within a cylindrical cavity inside the target capsule in the form of a pressed pellet or cast bead. To achieve good performance in radiography applications it is necessary for the focal spot size to be as small as possible and the activity to be as high as possible. This is achieved by irradiating in a very high neutron flux and by using very highly isotopically enriched ⁷⁴Selenium target material, typically >95% enrichment.

After the irradiation, the activated target capsule is welded into one or more outer metal capsules to provide a leak-free source, which is free from external radioactive contamination. Shilton goes on to disclose incorporation of ⁷⁴Selenium into a capsule of “acceptable” material.

Elemental selenium is chemically and physically volatile. It melts at 220° C. and boils at 680° C. It reacts with many metals, which might be suitable as low-activating capsule materials at temperatures above about 400° C.; these include titanium, vanadium and aluminum and their alloys. Selenium may react explosively with aluminum. This means that careful choice of target capsule material is required and the temperature of the target capsule during irradiation must be kept below about 400° C. to prevent the selenium from reacting with, and corroding, the target capsule wall. Erosion of the capsule wall increases the focal spot size, distorts the focal spot shape and reduces the wall thickness and strength of the target capsule.

Combining Selenium with other metals can overcome these deficiencies of low melting temperature and reactivity. However, in order to assure that the radiological properties of the resultant radioactive source are not unacceptably altered, it is necessary that the material being combined with the precursor does not activate into a radioactive species, or activates into a radioactive species with a short half-life relative to the desired radioactive species, or activates into a radioactive species which emits inconsequential radiation. In any of these cases, the resultant radioactive source would have no unwanted radiations from the material combined with the primary radionuclide or its precursor.

Since the advantage of pre-encapsulating the precursor material into a capsule that would not result in the long-lived emission of undesirable radiation is well known for the encapsulation process, it is also known that the same approach and the same materials may be combined with the precursor of the radioactive material in order to achieve materials with different physical or chemical properties. By combining a precursor with a material that would not result in the long-lived emission of undesirable radiation, the result would be a radioactive source with the physical and chemical properties of the combination but with no additional unwanted radiations.

Coniglione (U.S. Pat. No. 5,713,828), which is incorporated herein by reference, discloses a non-radioactive pre-seed in which a precursor isotope is plated or otherwise coated onto an “acceptable” substrate prior to neutron activation.

Armini (U.S. Pat. No. 6,060,036), which is incorporated herein by reference, discloses a device in which a precursor isotope is embedded beneath the surface of the carrier body to later neutron activate the combination to produce the single radioactive isotope without unwanted radioactive materials.

Munro (U.S. Pat. No. 6,400,796), which is incorporated herein by reference, discloses that the precursor may be compounded, mixed or alloyed with other materials chosen from those that contain minimally acceptable amounts of isotopes which, when irradiated by neutron flux, would be transmuted to radioactive isotopes that do not emit undesirable radiations or, if transmuted into radioactive isotopes that emit undesirable radiations, the isotopes have such short half-lives or very low dose rates that their activities will have little or no consequence. Munro provides as follows: “Materials which contain minimally acceptable amounts of undesirable radioactive isotopes or transmutable radioactive isotopes with short half-lives or very low dose rates include purified aluminum, copper, vanadium, nickel, iron, and/or oxygen.”

Fritz of AEA Technology (U.S. Pat. No. 6,770,019), which is incorporated herein by reference, discloses a radioactive radiation source in the form of a wire comprising a matrix of a ductile and/or plastic binder material and a radioactive and/or activatable material, where the plastic binder material has a low capture cross-section for the method of activation of the activatable material and/or a low attenuation factor for the emitted radiation, and, preferably, the ductile and/or plastic binder material comprises a metal, a metal alloy or mixtures thereof. Fritz goes on to enumerate a number of preferred radioactive and/or activated materials and includes ⁷⁵Selenium.

Menuhr of AEA Technology (U.S. Pat. No. 6,716,156), which is incorporated herein by reference, discloses a radioactive or activatable seed for use in brachytherapy consisting of a radioactive or activatable metallic material selected with a non-radioactive, non-activatable metallic material. The list of radioactive materials included ⁷⁵Selenium and the group of activatable precursor nuclides included ⁷⁴Selenium.

In the specific case of ⁷⁵Selenium, the combination of ⁷⁵Selenium (and its precursor material, ⁷⁴Selenium) with a material that would not result in the long-lived emission of undesirable radiation has also been well known, as set forth below.

### Sodium Selenide

Sodium is a metal with a natural abundance of 100% ²³Sodium. When subjected to neutron irradiation, ²³Sodium becomes ²⁴Sodium which decays with a half-life of 15 hours with the emission of gamma rays of 1369 keV and 2754 keV. Sodium would not result in the long-lived emission of undesirable radiation because of its short half-life of 15 hours. Numerous examples of this compound have been published, including: Monks (U.S. Pat. No. 4,024,234); Bayly (U.S. Pat. No. 4,030,886); Monks (U.S. Pat. No. 4,038,033); Monks (U.S. Pat. No. 4,083,947); Bayly (U.S. Pat. No. 4,202,976); and Kung H and Blau M, entitled “Synthesis of Selenium-75 Labelled tertiary Diamines: New Brain Imaging Agents” Journal of Medicinal Chemistry 23: 1127-1130 (1980), all of which are incorporated herein by reference.

### Sodium ⁷⁵Selenite (Na₂SeO₃)

Sodium and Selenium has also been combined with Oxygen to form the compound, Sodium ⁷⁵Selenite that would also not result in the long-lived emission of undesirable radiation. Several examples of this compound have also been published, including: Monks (U.S. Pat. No. 4,172,085); Monks (U.S. Pat. No. 4,202,876); Cree (U.S. Pat. No. 4,311,853); Lopez P L, Preston R L and Pfander W H “Whole-body Retention, Tissue Distribution and Excretion of Selenium-75 After Oral and Intravenous Administration in lambs Fed Varying Selenium Intakes”, Journal of Nutrition 97: 123-132 (1968), which are all incorporated herein by reference.

### Aluminum ⁷⁵Selenide

Aluminum is a metal with a natural abundance of 100% ²⁷Aluminum. When subjected to neutron irradiation, ²⁷Aluminum becomes ²⁸Aluminum which decays with a half-life of 2.3 minutes with the emission of a 2.85 MeV beta and a 1780 keV gamma ray. Alumium would not result in the long-lived emission of undesirable radiation because of its short half-life of 2.3 minutes. Two examples of this compound are described in: Zhuikov (U.S. Pat. No. 5,987,087) and Gordon (U.S. Pat. No. 4,106,488), which are incorporated herein by reference.

### Molybdenum ⁷⁵Selenide

Molybdenum is a metal with many naturally-occurring isotopes. However, upon neutron irradiation, the only isotope of consequence is ⁹⁹Molybdenum which decays with a half-life of 67 hours with the emission of a 1.23 MeV beta and a numerous gamma rays with energies up to 780 keV. Molybdenum would not result in the long-lived emission of undesirable radiation because of its short half-life of 67 hours. An example of this compound is found in Gordon (U.S. Pat. No. 4,106,488), which is incorporated herein by reference

### Copper ⁷⁵Selenide

Copper is a metal with a natural abundance of 69% ⁶³Copper and 31% ⁶⁵Copper. When subjected to neutron irradiation, ⁶³Copper becomes ⁶⁴Copper which decays with a half-life of 12 hours with the emission of gamma rays of 511 keV and 1345 keV. When subjected to neutron irradiation, ⁶⁵Copper becomes ⁶⁶Copper which decays with a half-life of 5.1 minutes with the emission of gamma rays of 1039 keV. Copper would not result in the long-lived emission of undesirable radiation because of its short half-life of 15 hours. An example of Copper ⁷⁵Selenide is found in a paper published in the International Journal of Radiation Applied Instrumentation, Part A, Applied Radiation and Isotopes, Vol. 38, No. 7, pp 521-525 (1987) by Dennis R. Phillips, David C. Moody, Wayne A. Taylor, Neno J. Segura and Brian D. Pate entitled “Electrolytical Separation of Selenium Isotopes from Proton Irradiated RbBr Targets,” which is incorporated herein by reference. The paper describes the separation of selenium isotopes from the RbBr target based upon the electrolytic deposition of the selenium (including ⁷⁵Selenium) as copper selenide.

U.S. Pat. No. 6,875,377 to Shilton, which is incorporated herein by reference herein, discloses a gamma radiation source comprising selenium-75 which is combined with an acceptable metal or metals in the form of a stable compound, alloy, or mixed metal phase, the acceptable metal or metals being a metal or metals the neutron irradiation of which does not produce products capable of sustained emission of radiation which would unacceptably interfere with the gamma radiation of selenium-75. Shilton also discloses a precursor for a gamma radiation source comprising isotopically enriched selenium-74 which combined with an acceptable metal or metals in the form of a stable alloy, compound, or mixed metal phase in an encapsulation, the encapsulation and its contents being adapted for irradiation with neutrons to convert at least some of the selenium-74 to selenium-75 whilst not at the same time producing any products capable of sustained emission of radiation which would unacceptably interfere with the gamma radiation of selenium-75.

However, Shilton recognized that there exist only a small collection of “acceptable” metals. Specifically, Shilton identified acceptable metal or metals as being from the group comprising vanadium, molybdenum, rhodium, niobium, thorium, titanium, nickel, lead, bismuth, platinum, palladium, aluminum, or mixtures thereof.

All of the above-identified prior art related to the combination of a radionuclide, or the precursor of a radionuclide, with an element, the neutron irradiation of which would not result in the long-lived emission of undesirable radiation. These identified materials are all based upon naturally occurring elements. Accordingly, it would be desirable to create materials which would not result in the long-lived emission of undesirable radiation by altering their isotopic composition.

### SUMMARY OF THE INVENTION

According to the system described herein, manufacturing a gamma radiation source includes providing an unacceptable material that is a combination of acceptable and unacceptable isotopes, transforming the unacceptable material into an acceptable material by removing unacceptable isotopes from the unacceptable material, leaving only acceptable isotopes, mixing selenium-74 and the acceptable material and heating the mixture to cause the constituents to inter-react and subsequently subjecting the reaction product to irradiation to convert at least a proportion of the selenium-74 to selenium-75. Manufacturing a gamma radiation source may also include adding at least one other acceptable material to the mixture. The at least one other acceptable material may be added to the mixture prior to heating the mixture. The unacceptable material may be selected from the group consisting of Zinc, Titanium, Nickel, Zirconium, Ruthenium, and Iron. The unacceptable material may be selected from the group consisting of: Silver, Indium, Thallium, Samarium, Ytterbium, Germanium, and Iridium. The acceptable material may be in a form of a dense, pore free pellet or bead. The pellet or bead may be contained within a sealed, welded, metal capsule. The pellet or bead may be formed to have a spherical or pseudo-spherical focal spot geometry.

According further to the system described herein, a precursor for a gamma radiation source includes an unacceptable material having acceptable and unacceptable isotopes where removal of the unacceptable isotopes renders the material an acceptable material for combination with ⁷⁴Se and subsequent irradiation wherein a result thereof has at least one of: gamma rays with energies below 401 keV and a half life less than 66 hours. The unacceptable material may be from the group consisting of: Zinc, Titanium, Nickel, Zirconium, Ruthenium, Iron, Silver, Indium, Thallium, Samarium, Ytterbium, Germanium, and Iridium. The acceptable material may be in a form of a dense, pore free pellet or bead. The pellet or bead may be contained within a sealed, welded, metal capsule. The pellet or bead may be formed to have a spherical or pseudo-spherical focal spot geometry. The pellet or bead may be formed to have a geometry which is octagonal in one section and circular in the transverse section.

According further to the system described herein, making a precursor for a gamma radiation source includes providing an unacceptable material that is a combination of acceptable and unacceptable isotopes and transforming the unacceptable material into an acceptable material by removing unacceptable isotopes from the unacceptable material, leaving only acceptable isotopes. The unacceptable material may be from the group consisting of: Zinc, Titanium, Nickel, Zirconium, Ruthenium, Iron, Silver, Indium, Thallium, Samarium, Ytterbium, Germanium, and Iridium. The acceptable material may be in a form of a dense, pore free pellet or bead. The pellet or bead may be contained within a sealed, welded, metal capsule. The pellet or bead may be formed to have a spherical or pseudo-spherical focal spot geometry. The pellet or bead may be formed to have a geometry which is octagonal in one section and circular in the transverse section.

A desired radioactive material may be produced using a precursor for a radiation source combined with a material which, in its natural state would not be an “acceptable” material (i.e. when irradiated by neutron flux, would be transmuted to radioactive isotopes that emit long-lived undesirable radiation), but is transformed into an “acceptable” material by the removal of most of the isotopes which caused this to be unacceptable.

### BRIEF DESCRIPTION OF THE DRAWINGS

Embodiments of the system described herein will now be explained in more detail in accordance with the figures of the drawings, which are briefly explained as follows.

FIG. 1 is a sectional view of an irradiation capsule assembly according to an embodiment of the system described herein.

FIG. 2 is an exploded view of the components shown in FIG. 1 according to an embodiment of the system described herein.

FIG. 3 is a sectional view of a modified irradiation capsule assembly according to an embodiment of the system described herein.

FIG. 4 is a side elevation of a component of the assembly shown in FIG. 3 according to an embodiment of the system described herein.

### DETAILED DESCRIPTION OF VARIOUS EMBODIMENTS

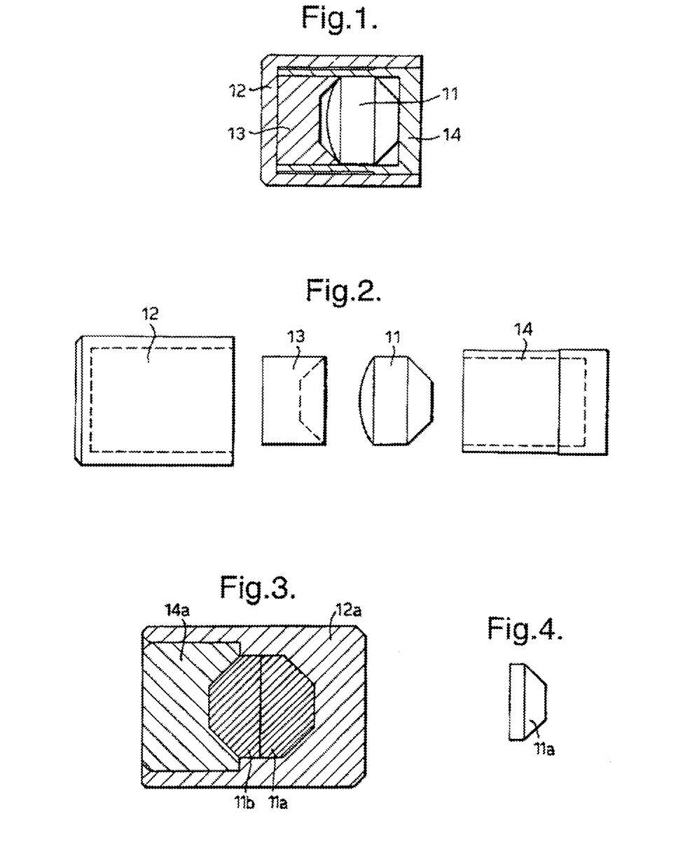

Referring to FIGS. 1 and 2 of the drawings, a pellet 11 incorporating selenium-75 is hermetically sealed in the capsule comprising a cylindrical body 12, a cylindrical plug 13 and a cylindrical lid component 14 one end of which is of slightly increased diameter. The plug 13 may be wholly received within the body 12 and welded to the body 12 around a part thereof which is of increased diameter. The pellet 11 may be held within the capsule clamped between the plug 13 and lid component 14.

The modified assembly shown in FIGS. 3 and 4 is generally similar, but involves a reduced number of components. The capsule includes a cylindrical body 12a and a cylindrical lid component 14a received in a correspondingly shaped recess in the body 12a. The lid 14a and the body 12a may be shaped internally to receive a pellet incorporating selenium-75 which is formed in two halves 11a and 11b, one of which, 11a, is shown in side elevation in FIG. 4. The pellet halves 11a and 11b may also have a cylindrical geometry so that, for the section shown the shape of the two halves 11a, 11b put together forms an octagon, but the shape in section at right angles to that shown is circular. After assembly, the lid 14a may be welded at 15 to the body 12a. Of course, other shapes and configurations are possible, consistent with the discussion herein.

The pellet compositions can be prepared by a variety of methods. In an embodiment a known quantity of enriched ⁷⁴Se powder is weighed with a calculated quantity of powdered acceptable material, and the mixture is heated in an inert, sealed container, such as a flame sealed glass ampoule, gradually increasing the temperature over several hours to the reaction temperature and then holding that temperature for several more hours. The result may be pressed into half octagonal section pellets 11a and 11b of the form shown in FIG. 4.

Cylindrical pellets or beads may be prepared by several methods. For example, powder can be cold-pressed, hot-pressed or sintered to form cylindrical, spherical or pseudo-spherical geometries which may be inserted into a target capsule, or cast or pressed in-situ. The capsule may then welded and leak tested prior to irradiation. The composition may contain some metal powder and elemental selenium. Excess elemental selenium may be purposefully added as a bonding agent to bond metal selenide particles together to form pore free, high density pellets or beads. Pellets, which are made of mixtures, may react or sinter together within the target capsule, either during a special annealing process prior to irradiation, or during the irradiation itself.

The system described herein provides that a desired radioactive material may be produced using a precursor for a radiation source combined with a material which, in its natural state would not be an “acceptable” material (i.e. when irradiated by neutron flux, would be transmuted to radioactive isotopes that emit long-lived undesirable radiation), but is transformed into an “acceptable” material by the removal of most of the isotopes that otherwise cause the material to be unacceptable.

In an embodiment herein, an unacceptable material and/or isotope of a material is one having gamma rays with energies above 401 keV and a half life greater than 66 hours. Of course, other criteria may be used for determining acceptable and unacceptable. The system described herein starts with an unacceptable material that is a combination of acceptable and unacceptable isotopes and then removes the unacceptable isotopes leaving only the acceptable isotopes. Removing the unacceptable isotopes transforms the unacceptable material into an acceptable material. Numerous examples exist, some of which are discussed as follows:

### Zinc ⁷⁵Selenide

For example, Zinc in its natural state is an unacceptable material. Natural Zinc is comprised of approximately 48.9% ⁶⁴Zinc, 27.8% of ⁶⁶Zinc, 4.1% of ⁶⁷Zinc and 18.6% of ⁶⁸Zinc and 0.6% of ⁷⁰Zinc When irradiated by neutron flux, ⁶⁴Zinc,an unacceptable iostope, is transmuted to radioactive ⁶⁵Zinc which emits high energy gamma rays (511 keV and 1115 keV) and has a half-life of 245 days. For this reason, Zinc would be considered an unacceptable material. However, when ⁶⁴Zinc is removed from the material, the remaining naturally occurring isotopes (acceptable isotopes), when irradiated by neutron flux, would be transmuted to radioactive isotopes that have half-lives of less than one hour. Therefore, the removal of ⁶⁴Zinc from an unacceptable material renders the resulting material an acceptable material which could be combined, for example, with precursor material ⁷⁴Selenium to form the compound ZnSe. This compound, when irradiated by neutron flux, would be transmuted to the desired radioactive ⁷⁵Selenium with no other isotopes that emit undesirable radiations with long half-lives.

### Titanium ⁷⁵Selenide

Titanium in its natural state is an unacceptable material. Natural Titanium contains approximately 8% ⁴⁶Titanium. When irradiated by a high energy neutron flux, ⁴⁶Titanium, an unacceptable isotope, is transmuted to radioactive 46Scandium [⁴⁶Ti (n,p) ⁴⁶Sc] which emits high energy gamma rays (889 keV and 1120 keV) and has a half-life of 84 days. For this reason, Titanium would be considered an unacceptable material. However, when ⁴⁶Titanium is removed from the material, the remaining naturally occurring isotopes (acceptable isotopes), when irradiated by neutron flux, would be transmuted to radioactive isotopes that have half-lives of less than two days. Therefore, the removal of ⁴⁶Titanium from an unacceptable material renders the resulting material an acceptable material which could be combined, for example, with precursor material ⁷⁴Selenium to form the compound TiSe₂. This compound, when irradiated by neutron flux, would be transmuted to the desired radioactive ⁷⁵Selenium with no other isotopes that emit undesirable radiations with long half-lives.

### Nickel ⁷⁵Selenide

Nickel in its natural state is an unacceptable material. Natural Nickel contains approximately 68% ⁵⁸Nickel. When irradiated by a high energy neutron flux, ⁵⁸Nickel, an unacceptable isotope, is transmuted to radioactive ⁵⁸Cobalt [⁵⁸Ni (n,p) ⁵⁸Co] which emits high energy gamma rays (511 keV, 810 keV) and has a half-life of 71 days. For this reason, Nickel would be considered an unacceptable material. However, when ⁵⁸Nickel is removed from the material, the remaining naturally occurring isotopes (acceptable isotopes), when irradiated by neutron flux, would be transmuted to radioactive isotopes that have half-lives of less than three days or with very low energies (⁶³Nickel, 67 keV beta). Therefore, the removal of ⁵⁸Nickel from an unacceptable material renders the resulting material an acceptable material which could be combined, for example, with precursor material ⁷⁴Selenium to form the compound NiSe₂. This compound, when irradiated by neutron flux, would be transmuted to the desired radioactive ⁷⁵Selenium with no other isotopes that emit undesirable radiations with long half-lives.

### Zirconium ⁷⁵Selenide

Zirconium in its natural state is an unacceptable material. Natural Zirconium is comprised of five staple isotopes, as shown in TABLE 1:

TABLE 1

| | Abun- | | Half- | |
|---|---|---|---|---|
| Isotope | dance | Produces | life | Radiations |
| ⁹⁰Zr | 51.45% | ⁹¹Zr | Stable | |
| ⁹¹Zr | 11.27% | ⁹²Zr | Stable | |
| ⁹²Zr | 17.17% | ⁹³Zr | 1.5 E6 y | Low Energy β⁻ (91 keV), |
| | | | | X-rays of 16-18 keV, |
| | | | | Gamma of 31 keV |
| ⁹⁴Zr | 17.33% | ⁹⁵Zr | 64.03 d | High Energy β⁻ (1100 keV), |
| | | | | Gammas of 724, 757 keV |
| ⁹⁶Zr | 2.78% | ⁹⁷Zr | 16.8 h | High Energy β⁻ (2 MeV), |
| | | | | Gammas of 743 keV |
| | | | | Others up to 2 MeV |

When irradiated by a high neutron flux, the only isotope of interest is ⁹⁴Zirconium, an unacceptable isotope, which is transmuted to radioactive ⁹⁵Zirconium which emits high energy gamma rays (724 keV, 757 keV) and has a half-life of 64 days. For this reason, Zirconium would be considered an unacceptable material. However, when ⁹⁴Zirconium is removed from the material, the remaining naturally occurring isotopes (acceptable isotopes), when irradiated by neutron flux, would be transmuted to radioactive isotopes that have half-lives of less than one day or with very low energies (⁹³Zirconium, 31 keV gamma). Therefore, the removal of ⁹⁴Zirconium from an unacceptable material renders the resulting material an acceptable material which could be combined, for example, with precursor material ⁷⁴Selenium to form the compound ZrSe₃. This compound, when irradiated by neutron flux, would be transmuted to the desired radioactive ⁷⁵Selenium with no other isotopes that emit undesirable radiations with long half-lives.

### Ruthenium ⁷⁵Selenide

Ruthenium in its natural state is an unacceptable material. Natural Ruthenium is comprised of seven staple isotopes, as shown in TABLE 2:

TABLE 2

| | Abun- | | Half- | |
|---|---|---|---|---|
| Isotope | dance | Produces | life | Radiations |
| ⁹⁶Ru | 5.52% | ⁹⁷Ru | 2.89 d | |
| ⁹⁸Ru | 1.88% | ⁹⁹Ru | Stable | |
| ⁹⁹Ru | 12.70% | ¹⁰⁰Ru | Stable | |
| ¹⁰⁰Ru | 12.60% | ¹⁰¹Ru | Stable | |
| ¹⁰¹Ru | 17.00% | ¹⁰²Ru | Stable | |
| ¹⁰²Ru | 31.60% | ¹⁰³Ru | 39.24 d | 497, 610 keV gammas |
| ¹⁰⁴Ru | 18.70% | ¹⁰⁵Ru,¹⁰⁵Rh, | 4.44 h | 317, 400, 475, 670, |
| | | ¹⁰⁶Ru | | 726 keV gammas |
| | | | 35.4 h | 306, 319 keV gammas |
| | | | 372 d | 3.54 MeV beta, 512, |
| | | | | 622, gammas |

When irradiated by a high neutron flux, the only isotope of interest is ¹⁰²Ruthenium, an unacceptable isotope, which is transmuted to radioactive ¹⁰³Ruthenium which emits high energy gamma rays (497 keV, 610 keV) and has a half-life of 39 days. For this reason, Ruthenium would be considered an unacceptable material. However, when ¹⁰²Ruthenium is removed from the material, the remaining naturally occurring isotopes (acceptable isotopes), when irradiated by neutron flux, would be transmuted to radioactive isotopes that have half-lives of less than three days or with very low energies or with very low production (¹⁰⁶Ruthenium/¹⁰⁶Rhodium). Therefore, the removal of ¹⁰²Ruthenium from an unacceptable material renders the resulting material an acceptable material which could be combined, for example, with precursor material ⁷⁴Selenium to form the compound RuSe₂. This compound, when irradiated by neutron flux, would be transmuted to the desired radioactive ⁷⁵Selenium with no other isotopes that emit undesirable radiations with long half-lives.

Ruthenium Selenide (RuSe₂) is very thermally stable, and significantly denser than elemental Selenium, which results in a higher effective Selenium density. Therefore, for the same irradiation conditions, higher effective (output) activity is expected for a given focal size, making this a preferred compound for a ⁷⁵Selenium source.

### Iron ⁷⁵Selenide

Iron in its natural state is an unacceptable material. Natural Iron is comprised of four staple isotopes, as shown in TABLE 3:

TABLE 3

| | Abun- | | Half- | |
|---|---|---|---|---|
| Isotope | dance | Produces | life | Radiations |
| ⁵⁴Fe | 5.85% | ⁵⁵Fe | 2.6 y | 6 keV X-rays |
| ⁵⁶Fe | 91.75% | ⁵⁷Fe | Stable | |
| ⁵⁷Fe | 2.12% | ⁵⁸Fe | Stable | |
| ⁵⁸Fe | 0.28% | ⁵⁹Fe | 44.5 days | High Energy Gammas of |
| | | | | 1099 and 1292 keV |

When irradiated by a high neutron flux, the only isotope of interest is ⁵⁸Iron, an unacceptable isotope, which is transmuted to radioactive ⁵⁹Iron which emits high energy gamma rays (1099 keV, 1292 keV) and has a half-life of 44.5 days. For this reason, Iron would be considered an unacceptable material. However, when ⁵⁸Iron is removed from the material, the remaining naturally occurring isotopes (acceptable isotopes), when irradiated by neutron flux, would be transmuted to radioactive isotopes that have half-lives of less than one day or with very low energies (⁵⁵Iron, 6 keV X-rays). Therefore, the removal of ⁵⁸Iron from an unacceptable material renders the resulting material an acceptable material which could be combined, for example, with precursor material ⁷⁴Selenium to form the compound FeSe₂. This compound, when irradiated by neutron flux, would be transmuted to the desired radioactive ⁷⁵Selenium with no other isotopes that emit undesirable radiations with long half-lives.

Other examples exist that may be used according to the system described herein. For example:

Silver ⁷⁵Selenide (Ag₂Se) using Silver depleted in ¹⁰⁹Ag;

Indium ⁷⁵Selenide (In₂Se₃) using Indium depleted in ¹¹³In;

Thallium ⁷⁵Selenide (Tl₂Se₃) using Thallium depleted in ²⁰³Tl;

Samarium ⁷⁵Selenide (SmSe) using Samarium depleted in ¹⁴⁴Sm;

Ytterbium ⁷⁵Selenide (Yb₂Se₃) using Ytterbium depleted in ¹⁶⁹Yb;

Germanium ⁷⁵Selenide (GeSe₂) using Germanium depleted in ⁷⁰Ge; and

Iridium ⁷⁵Selenide (IrSe₃) using Iridium depleted in ¹⁹³Ir;

among others

Various embodiments discussed herein may be combined with each other in appropriate combinations in connection with the system described herein. In addition, it is possible to combine the materials described herein with one or more other acceptable materials prior to or possibly after irradiation without departing from the spirit and scope of the invention. For example, it is possible to combine Ruthenium Selenide with any of the acceptable materials mentioned in U.S. Pat. No. 6,875,377 to Shilton and/or with any of the acceptable materials directly mentioned herein. Alternatively, it is possible to provide a finished element having only the materials mentioned directly herein (e.g., containing only Ruthenium Selenide).

Other embodiments of the invention will be apparent to those skilled in the art from a consideration of the specification or practice of the invention disclosed herein. It is intended that the specification and examples be considered as exemplary only.

What is claimed is:

1. A method of manufacturing a gamma radiation source, comprising:
providing an unacceptable material that is a combination of acceptable and unacceptable isotopes;
transforming the unacceptable material into an acceptable material by removing unacceptable isotopes from the unacceptable material, leaving only acceptable isotopes;
mixing selenium-74 and the acceptable material; and
heating the mixture to cause the constituents to inter-react and subsequently subjecting the reaction product to irradiation to convert at least a proportion of the selenium-74 to selenium-75.

2. A method, according to claim 1, further comprising:
adding at least one other acceptable material to the mixture.

3. A method, according to claim 2, wherein the at least one other acceptable material is added to the mixture prior to heating the mixture.

4. A method, according to claim 1, wherein the unacceptable material is selected from the group consisting of: Zinc, Titanium, Nickel, Zirconium, Ruthenium, and Iron.

5. A method, according to claim 1, wherein the unacceptable material is selected from the group consisting of: Silver, Indium, Thallium, Samarium, Ytterbium, Germanium, and Iridium.

6. A method as claimed in claim 1, wherein the acceptable material is in a form of a dense, pore free pellet or bead.

7. A method as claimed in claim 6, wherein the pellet or bead is contained within a sealed, welded, metal capsule.

8. A method as claimed in claim 6, wherein the pellet or bead is formed to have a spherical or pseudo-spherical focal spot geometry.

9. A precursor for a gamma radiation source comprising an unacceptable material having acceptable and unacceptable isotopes wherein removal of the unacceptable isotopes renders the material an acceptable material for combination with ⁷⁴Se and subsequent irradiation wherein a result thereof has at least one of: gamma rays with energies below 401 keV and a half life less than 66 hours.

10. A precursor as claimed in claim 9, wherein the unacceptable material is from the group consisting of: Zinc, Titanium, Nickel, Zirconium, Ruthenium, Iron, Silver, Indium, Thallium, Samarium, Ytterbium, Germanium, and Iridium.

11. A precursor as claimed in claim 9, wherein the acceptable material is in a form of a dense, pore free pellet or bead.

12. A precursor as claimed in claim 11, wherein the pellet or bead is contained within a sealed, welded, metal capsule.

13. A precursor as claimed in claim 11, wherein the pellet or bead is formed to have a spherical or pseudo-spherical focal spot geometry.

14. A precursor as claimed in claim 13, wherein the pellet or bead is formed to have a geometry which is octagonal in one section and circular in the transverse section.

15. A method of making a precursor for a gamma radiation source, comprising:
providing an unacceptable material that is a combination of acceptable and unacceptable isotopes; and
transforming the unacceptable material into an acceptable material by removing unacceptable isotopes from the unacceptable material, leaving only acceptable isotopes.

16. A method as claimed in claim 15, wherein the unacceptable material is from the group consisting of: Zinc, Titanium, Nickel, Zirconium, Ruthenium, Iron, Silver, Indium, Thallium, Samarium, Ytterbium, Germanium, and Iridium.

17. A method as claimed in claim 15, wherein the acceptable material is in a form of a dense, pore free pellet or bead.

18. A method as claimed in claim 17, wherein the pellet or bead is contained within a sealed, welded, metal capsule.

19. A method as claimed in claim 17, wherein the pellet or bead is formed to have a spherical or pseudo-spherical focal spot geometry.

20. A method as claimed in claim 19, wherein the pellet or bead is formed to have a geometry which is octagonal in one section and circular in the transverse section.
